(19) United States
(12) Patent Application Publication
(10) Pub. No.: US 2008/0057332 A1
(43) Pub. Date: Mar. 6, 2008

(54) Methods for making hollow metal spheres

(75) Inventors: Timothy M. Owens, Summerville, SC (US); Douglas DuFaux, Orchard Park, NY (US); Gary Bockman, Lockport, NY (US); Scott Brockman, Lockport, NY (US); Kenneth Hammond, Lockport, NY (US)

Correspondence Address: GREENBERG TRAURIG, LLP, ONE INTERNATIONAL PLACE, 20th FL, ATTN: PATENT ADMINISTRATOR, BOSTON, MA, 02110, US

(73) Assignee: NanoDynamics, Inc.

(21) Appl. No.: 11/821,758

(22) Filed: Jun. 25, 2007

Related U.S. Application Data
(60) Provisional application No. 60/816,704, filed on Jun. 26, 2006.

(51) Int. Cl. F16C 33/32; A63B 39/00; B23K 15/00; B23P 15/00

(52) U.S. Cl. 428/544; 29/898.053; 29/898.069; 29/899.1; 384/627

(57) ABSTRACT

A method for the manufacture of hollow metal spheres is provided. The method includes stamping appropriately-shaped hemispherical components and subsequently laser welding of the hemispheres. Metal spheres made by the method of the invention are substantially uniformly symmetrical in their mass distribution, and can provide superior performance in applications, such as golf ball cores and light-weight ball bearings.

### RELATED US APPLICATION(S)

This application claims priority to U.S. Provisional Application Ser. No. 60/816,704, filed Jun. 26, 2006, which application is hereby incorporated herein by reference.

### FIELD OF THE INVENTION

The invention relates generally to the fields of metalworking and welding, and more particularly, to processes for making hollow metallic spheres.

### BACKGROUND OF THE INVENTION

High-precision hollow metal spheres have found specialized uses over the years, particularly as light-weight ball bearings in aviation and aerospace applications, where minimal weight is highly desirable. More recently, hollow metal spheres have found use as the cores of golf balls. The precision manufacture of hollow ball bearings has been a considerable challenge, with the bulk of research and development attention being focused on methods for precisely aligning and joining hemispherical components, while maintaining mechanical strength and symmetrical mass distribution. Similar difficulties have attended the development of hollow metal cores for golf balls. The difficulties are such that hollow ball bearings are considered candidates for manufacture in orbit, and zero-gravity experiments toward that end have been carried out in space.

The simplest approach to making a hollow metal sphere is the welding of a butt joint between two hemispheres. This leaves a bead of excess material, or flash, along the seam. Although flash on the outer surface of a sphere is easily removed by routine methods (e.g., by milling between rill plates), the flash on the inner surface remains, and the resulting uneven weight distribution can result in dynamic instability and vibration at high speeds. Also, because the microstructure of the weld is different from the rest of the sphere, the weld often has a different elastic modulus, and the resulting focus of stress and deformation, often compounded by embrittlement, can lead to failure at the weld.

In U.S. Pat. No. 3,536,368 to Eklund and Campbell, and in U.S. Pat. No. 3,772,750 to Hauser, two hemispherical shells having mating tongue-and-groove arrangements are joined and welded or brazed together. U.S. Pat. No. 3.599,307 to Campbell and Johnson, the two hemispheres are “swaged” together by compression.

U.S. Pat. Nos. 3,470,720 and 3,774,280 to Eklund and Campbell disclose methods for “spin forging” a section of metal tubing into a hollow ball between a pair of rotating dies, and sealing the open ends by forge welding.

Glenn, in U.S. Pat. Nos. 3,660,880 and 3,731,359, discloses an apparatus for the automated drawing and forging of sheet metal stock into hemispheres, and for the subsequent electrical welding of the hemispheres into hollow balls.

Braginsky et al., in U.S. Pat. No. 5,659,956, disclose a friction-welding method, wherein the edges of two hemispheres spinning at different rates are pressed together with sufficient force that frictional heating melts the metal at the interface.

The use of hollow metal spheres as cores for golf balls is disclosed in U.S. Pat. Nos. 6,004,225 and 6,705,957 and in references therein. Due to the higher angular moment of inertia of golf balls of this construction, the impact of a golf club imparts less side-spin than it does to traditional solid-core balls, resulting in improved performance characteristics, such as a flight path with a reduced hook or slice. In addition, the hollow metal core provides the designer with an additional degree of freedom to tailor the response of the ball to the impact of the golf club.

Like a high-performance ball bearing, the core of a golf ball must have the strength to resist enormous forces without failure, and it must have its mass distributed with nearly perfect spherical symmetry if it is to perform properly. It is well-known that a non-symmetrical spinning object is most stable when the plane of greatest mass is perpendicular to the spin axis, and a sphere spinning about any other axis will experience a torque and undergo a change of spin axis until the most stable arrangement is met. The resulting precession or wobbling leads to undesirable vibration in a ball bearing, and unpredictable flight for a golf ball. For this reason, variations in the thickness of the sphere, and the presence of welding seams or beads on the inner surface, must be minimized or eliminated.

The referenced patents describe manufacturing processes for a hollow metal core to be used in golf balls, but the manufacture of suitably symmetric cores remains problematic, given the demanding specifications required for consistent golf ball performance and for conformance with the symmetrical performance characteristics specified by the USGA Rules of Golf. A hollow metal core must also be hermetically sealed, to prevent outgassing, bubble formation, and delamination of the metal core from the next adjacent layer in the ball, which is typically a hard, resilient polymer. Finally, any welds, seams or other localized inhomogeneities in the microstructure of the metal core must not give rise to stress concentrations or mechanical weaknesses that would impair the ability of the core to withstand the force of being hit with a golf club. Similar demands are placed on hollow spheres that are to be used as bearings in aerospace applications, for example as a thrust bearings in commercial jet engines.

There remains a need for methods to economically and reproducibly manufacture hermetically sealed hollow metal spheres that have high strength and impact resistance, and that have their mass distributed with a high degree of spherical symmetry.

### SUMMARY OF THE INVENTION

An objective of the present invention is the manufacture of a symmetrically performing hollow metal sphere for use as a golf ball core or ball bearing. The present inventors have observed that certain stamping and welding techniques are superior to others in producing a hermetically sealed sphere with a highly symmetrical mass distribution. More particularly, the invention provides methods for stamping sheet metal stock into hemispheres of substantially uniform thickness without inducing undesirable metallurgical transformations. The hemispheres may be produced with specific dimensional characteristics so that, when welded together by a suitable method, the result provides a substantially symmetrical hollow metal sphere. The invention also provides a laser welding method for joining two such metal hemispheres together, which has been found to yield superior results.

### BRIEF DESCRIPTION OF THE FIGURES

FIG. 1 depicts a metal hemisphere having appropriate dimensions for use in the methods of the present invention, where the height h equals the radius r plus an increment x.

FIG. 2 depicts a metal sphere prepared by the method of the invention, wherein the welding operation has reduced the hemisphere height h by the increment x so as to equal the radius r.

### DETAILED DESCRIPTION OF THE INVENTION

In spite of the simple geometry of a hollow metal sphere, the high-volume production of this article with high precision is not a straightforward process. Prior art methods that require precise machining and joining of two hemispheres are not economical, and do not permit high-volume production. One economical approach to producing a hollow metal sphere includes first stamping out two hemispheres of a specific metal or alloy, and then joining these two halves together to form the sphere. Joining methods other than welding (e.g., gluing, riveting, soldering, etc.) produce joints that may not withstand severe impacts, such as that of a golf club striking a golf ball, and a hollow sphere assembled by such methods will be prone to splitting along the joint.

Although welding can be a preferred method of joining, most welding techniques will not yield the highly uniform and precise spheres required for applications such as aerospace bearings and golf ball cores. Specifically, the welding method must leave little or no excess flash or beading on the inner surface of the sphere, as any such excess material can disrupt the spherically symmetrical weight distribution necessary to high performance in a golf ball or bearing.

The present invention provides a method for forming metal hemispheres and joining them by welding, in a way that produces a hollow metal core with substantially symmetrical performance upon impact by a golf club. The spheres made by the method of the present invention can also withstand the process of polymer coating via injection molding, which in golf ball manufacture can involve pressures in excess of 30,000 psi. Metal spheres made according to the present invention, may be hermetically sealed, with substantially no leakage of gases into the interstitial space between the metal surface and the polymer layer during the manufacturing process. The method of the present invention also provides for precision joining of metal hemispheres at high volume on a high-speed assembly line.

1. Stamping Metal Hemispheres

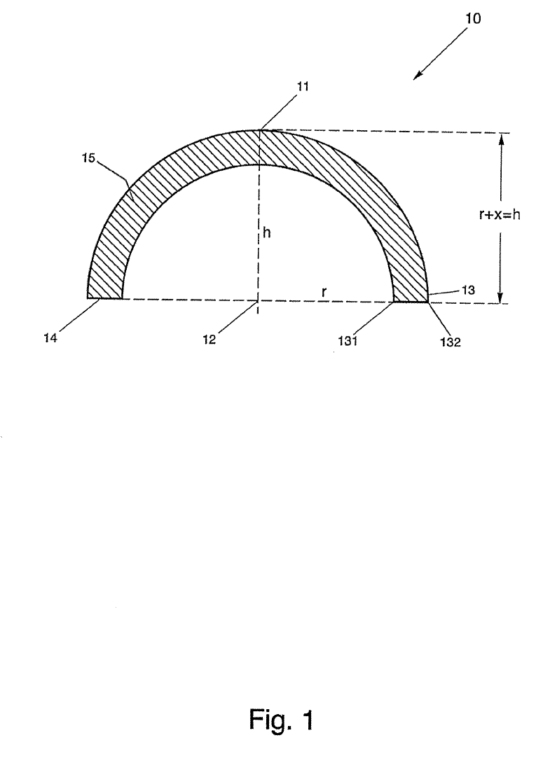

With reference now to FIG. 1, the method of the present invention, in an embodiment, employs a stamping tool (not shown) designed to generate a hemisphere 10 with a height h from pole 11 to center 12 that may be approximately 1 to 4 thousandths of an inch greater than radius r from the center 12 of the hemisphere 10 to rim 13. This excess allows for shrinkage at weld face plane P that can subsequently occur during welding, such as by laser and/or electron beam welding, of two opposing hemispheres 10 to one another. The stamping step also creates a flat weld face 14 that allows for precision alignment between opposing hemispheres 10 during welding. Stamping the hemispheres 10 from various metals and alloys can preferably be carried out, in an embodiment, with a limited number of strikes so as to avoid excessive work-hardening of the material.

In general, metal stamping is a manufacturing process that takes metal in sheet form and presses it into three-dimensional forms to make various parts and articles. It is heavily used in the automotive industry to make various body parts and other automotive parts. However, it has not been utilized in the golf ball industry because the modern ball, until recently, has not contained any metal parts. Many metals can be formed into various shapes using the stamping process, but in a hollow metal golf ball core, the dimensional and physical properties of the finished piece can be critical in obtaining a golf ball with substantially consistent performance upon impact by a golf club.

In accordance with an embodiment, the stamping tool may be a transfer press, which can be a relatively inexpensive apparatus, but which can also be relatively slow. For high-volume manufacturing, the press may preferably be a progressive die press, in which the workpiece can be held throughout the stamping process.

It has been shown that metal stamping using a transfer press or a progressive die press can be well-suited for forming the types of metals that may be used in making hollow metal cores for golf balls. The initial strike on a strip of the metal of a specified thickness can produce a substantially flat cut-out disk called a blank. The flat blank of specified thickness can then gradually be formed into a hemisphere, such as hemisphere 10, through several subsequent strikes, with the final strike being predominantly responsible for the flatness of the weld face 14 of the hemisphere 10. It has been found that a substantially high degree of flatness of the weld face 14 (i.e., annular surface) may be necessary for proper alignment and proper weld penetration during the welding process. This flatness can be controlled to be within at least about 0.01 inch, preferably controlled to be within about 0.005 inch, and more preferably controlled to be within about 0.002 inch in flatness, around the circumference of the weld face 14 and radially from inner edge 131 to the outer edge 132 of rim 13, relative to the “plane of the equator” of the hemisphere 10. In other words, the weld face 14 or annular surface may be provided with a flatness that deviates no more than about 0.01 inches from a plane perpendicular to an axis of hemisphere 10.

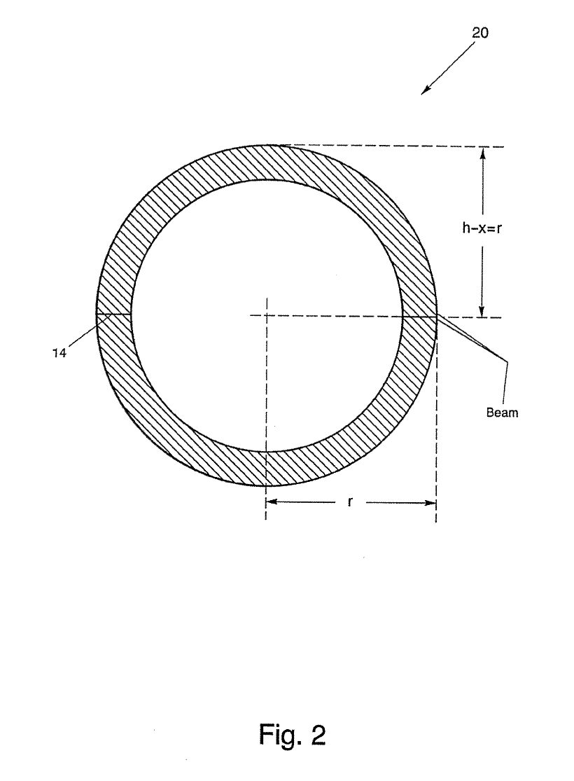

Still referring to FIG. 1, suitable hemispheres 10 for use in connection with the present invention may further have a ratio of height h to radius r ranging from about 1.0005 to about 1.02, more preferably from about 1.0005 to about 1.007. Hemisphere 10 may also have a wall 15, which can vary in thickness depending on the material used. The intended use of the hemisphere 10, as well as the desired mass of finished sphere 20 (See FIG. 2), and may be selected by the practitioner according to methods known in the art.

2. Materials

It should be appreciated that hundreds of materials suitable for ball bearings are known in the art, and by way of example, they include but are not limited to chrome, low alloy, high carbon, and stainless steels, such as M50 and the like, and various aluminum, magnesium, bronze, titanium, and cobalt alloys. Suitable materials for golf balls are similarly wide-ranging, including stainless steel, titanium, and tungsten. A particularly suitable metal may be steel sold by the Sandvik Group (Sweden) under the trademark Nanoflex™.

One example of a well-performing ball, in accordance with an embodiment of the present invention, is a ball made with a hollow 301 stainless steel (¼ hard) core having a thickness of approximately 0.039 inches and a diameter of about 1.1 inches, surrounded by a layer of a high resilience, low compression polymer, such as DuPont HPF 2000™, and having an ionomer cover with a thickness of about 0.063 inches.

Another example of a well-performing ball may be one that includes a hollow titanium (Grade 2) core having a thickness of approximately 0.071 inches and a diameter of about 1.364 inches, and having an ionomer cover with a thickness of approximately 0.158 inches. This ball has a moment of inertia that is approximately 20% higher than a conventional 2-piece ball.

Both of the hollow metal cores in these balls are made by stamping two metal hemispheres and welding them together using a laser beam welding process, according to the methods disclosed hereinafter. These balls have been shown to have similar launch parameters (initial speed and backspin) to commercially available premium golf balls. Golf ball having cores made using the method of the present invention and having a core diameter ranging from about 0.8 in to about 1.5 in have exhibited similar launch parameters.

3. Welding

Looking now to FIG. 2, in accordance with one embodiment of the present invention, welding can be used to couple the opposing hemispheres 10 to one another. In an embodiment, a high energy beam, such as a laser beam may be used. Laser welding, in general, is an industrial process which does not require operation in a vacuum. As a result, this process can reduce welding down-time during the load-weld-unload process cycle for a particular metal part, thereby allowing for substantially high volume production. Moreover, no additional material is required with the laser welding process, and relatively little heat energy is transferred beyond the weld surfaces 14 to adjoining areas of the part (i.e., hemispheres 10), so that material properties can largely be preserved during the welding operation.

Laser welding, in particular, melts the material on the weld face 14 to permit the weld faces 14 in the adjoining hemispheres 10 to fuse during the process. However, due to the transition to the liquid phase, there may be some shrinkage involved, which can affect the pole-to-pole height of a resulting hollow metal sphere 20. An allowance of additional material on each hemisphere 10 in the stamping process, as noted above, can compensate for this shrinkage, which, for a golf ball core, can typically be on the order of about 1 to 4 thousandths of an inch.

Suitable lasers that can be employed in connection with the process of the present invention include, but are not limited to, CO₂ and Nd:YAG lasers. The laser may be operated in pulsed or continuous mode, but preferably in continuous mode. Suitable beam widths of the laser can range from about 0.005 inches to about 0.025 inches, with a beam width of about 0.010 inches being preferred. Furthermore, it should be appreciated that focal length of the beam delivery lens on the laser can be selected for convenient access to the workpiece, and to provide suitable energy density at high penetration. In an embodiment, a focal length of between about 5 and about 15 inches, and more preferably between about 5 and about 10 inches may be used. In this way, the beam can be focused within ±0.1 inches of the outer surface of the sphere 20, and more preferably within ±0.05 inches, during welding.

Suitable power levels, in one embodiment, may range from about 100 W to about 3.5 kW, and preferably between about 200 W and about 2 kW. For golf ball cores, the power level may range from about 500 W to about 1.5 kW. Those skilled in the art will appreciate that the power level can vary depending on, among other things, the dimensions of the hemispheres 10 and the velocity at which the piece (i.e., hemisphere 10) moves through the laser beam, the melting point and thermal conductivity of the metal used, and whether the laser being used is in continuous or pulsed mode. Moreover, it should be noted that the power level may be chosen, so as to obtain between about 10% and about 100% penetration of the thickness of the hemispheres 10, and may preferably be selected, so as to obtain no less than about 80% weld penetration. More preferably, the penetration may be no less than 90%, and most preferably may be about 100%. The power level, furthermore, should be set to a level which does not heat the metal on either side of a weld seam sufficiently to change the desired properties of the resulting sphere 20. Power can be measured in an embodiment, “on the meter” by reference to, for instance, a built-in monitoring device, or at the workpiece by actual measurement, for instance, with a laser calorimeter or thermopile sensor.

In accordance with one embodiment of the invention, the laser beam may be incident at an angle to an “equatorial plane” defined by the intersection of the two hemispheres 10, rather than within the plane P. This angle may be up to about 45°, but can preferably be less than about 15°, and more preferably can be less than about 10°. Most preferably, the angle can be about 7°. It should be appreciated that although a laser welding is discussed herein, other welding methods known in the art may also be used, for instance electric beam welding.

With respect to moving the piece (i.e. adjoining hemispheres 10) relative to the beam, various methods are known in the art, and may be suitable for use in connection with the present invention. In one embodiment, opposing hemispheres 10 may be held together and rotated about their common axis, so as to pass the joined region 21 continuously through the laser beam. A suitable linear velocity, or weld rate, has been found to be about 150 inches/minute. At this rate, a golf ball core can be substantially completely welded in about 1.35 seconds.

Welding, in an embodiment, can be initiated with the piece already rotating, and can be terminated by defocusing the laser beam over the course of about 100 msec after the piece has been rotated about 360°. This gradual powering down permits molten (i.e., melted) metal to fill in the irradiated volume or area, and to solidify in place. If the laser were to be instantaneously turned off, this tends to leave a hole at the point last irradiated.

To minimize the formation of pinholes in the final weld, it has been found that an axial force may be applied to push the opposing hemispheres 10 against one another. In one embodiment, pinhole formation was greatly reduced when the axial force approaches about 30 pounds, and can be virtually eliminated by an axial force of about 40 pounds or more.

To the extent that oxidizable metals, including titanium and non-stainless steels, are utilized in the formation of the sphere 20, the laser welding process of the present invention may be carried out under a protective flow of inert gas, such as helium, argon or nitrogen to minimize occurrences of oxidation. Those skilled in the art can select an atmosphere appropriate to the material being welded.

The welded sphere 20 may optionally be given one or more thermal treatments, such as annealing, tempering, case-hardening, and the like, in order to reduce internal stresses associated with the weld, to reduce gradients in physical properties at the weld, and/or to impart desirable physical properties to the sphere, as is known in the art for the particular metal employed.

By way of example, suitable combinations of beam width, power level, material dimensions and composition, and work velocity are found in the Examples below.

### EXAMPLE

As noted above, a well performing ball in accordance with an embodiment of the present invention may be made from a hollow 301 ¼ stainless steel core. To make such a core, a 301 ¼ hard stainless steel was used to form blanks. In one embodiment, the blanks were formed utilizing a transfer press, at a rate of 40 strokes per minute using a four-station tool with the first station cutting out the blanks. The tool comprised a male punch and a matching die suitable to produce a hemisphere having a radius of about 0.055 inches, a wall thickness of about 0.039 inches, and a weld face flatness tolerance of ±0.001 inches. Fabrication of such tooling is routine for one skilled in the art.

The hemispheres were then loaded into a laser welding system comprising a handling device that is designed to hold the two hemispheres substantially aligned in a position such that, upon welding, a sphere can be produced. The laser employed was a 1.7 kW Convergent Laser Arrow Ultimate™ (ARO Inc.), fitted with a 7.5 inch focal length lens. The hemispheres were pressed together with about 40 pounds of force. Once in position, the two hemispheres were rotated under a 1040 watt CO₂ laser beam (1130 W on the device's meter) that was focused to a roughly rectangular beam image 0.010 inches wide and 0.030 inches long, relative to the direction of welding. The rate of rotation was 1.35 seconds per revolution, or 44.4 rpm. The beam was inclined at an angle of 7° relative to the equatorial plane of the hemispheres. At the end of the weld the handling device continued to turn the sphere about another 0.25 inches, for an overlap which ensures that the welded seam is complete, during which period the laser beam was defocused. The beam was then turned off, the welded sphere dropped into a bin, and two more hemispheres put in place.

While the invention has been described with reference to particular embodiments, it will be understood by those skilled in the art that various changes may be made and equivalents may be substituted for elements thereof without departing from the scope of the invention. In addition, many modifications may be made to adapt a particular situation or material to the teachings of the invention without departing from the scope of the invention.

Therefore, it is intended that the invention not be limited to the particular embodiments disclosed, but that the invention will include all embodiments falling within the scope and spirit of the appended claims.

We claim:

1. A method for making a hollow metal sphere, the method comprising:
(a) providing at least two opposing metal hemispheres each having an exterior radius, an exterior height slightly greater than the radius, and annular surface defined by the edges of the inner and outer surfaces of each hemisphere;
(b) aligning the hemispheres coaxially with their annular surfaces in contact;
(c) rotating the two hemispheres about their common axis; and
(d) focusing a high energy beam at a point where the annular surfaces are in contact, so as to weld the opposing hemispheres together into a sphere, such that each hemisphere in the resulting sphere has an exterior height that is substantially similar to its exterior radius.

2. A method as set forth in claim 1, wherein the step of providing includes stamping, from a sheet of metal, blanks from which the opposing metal hemispheres are formed.

3. A method as set forth in claim 2, wherein the step of providing further includes forming each blank into a metal hemisphere with three or fewer strikes.

4. A method as set forth in claim 1, wherein, in the step of providing, the exterior height and exterior radius has a height to radius ratio between about 1.0005 and about 1.02.

5. A method as set forth in claim 1, wherein, in the step of providing, the annular surface has a flatness that deviates no more than about 0.01 inches from a plane perpendicular to an axis of the hemisphere.

6. A method as set forth in claim 1, wherein, in the step of providing, the hemispheres are made from stainless steel.

7. A method as set forth in claim 1, wherein, in the step of providing, the hemispheres are made from Nanoflex™ steel.

8. A method as set forth in claim 1, wherein, in the step of providing, the hemispheres are made from Grade 2 titanium.

9. A method as set forth in claim 1, wherein the step of aligning includes applying a force sufficient to press the opposing hemisphere against one another.

10. A method as set forth in claim 9, wherein the step of applying acts to minimize formation of holes in the weld between the hemispheres.

11. A method as set forth in claim 1, wherein the step of rotating includes a linear velocity of about 150 in/min.

12. A method as set forth in claim 1, wherein, in the step of focusing, the high energy beam is a laser beam.

13. A method as set forth in claim 1, wherein the step of focusing includes defocusing the beam over a period of about 100 msec after the opposing hemispheres have rotated about 360 degrees.

14. A method as set forth in claim 1, wherein the step of focusing includes providing the opposing hemispheres with a weld having at least 90% penetration of the thickness of the hemispheres.

15. A method as set forth in claim 1, wherein the step of focusing includes providing the opposing hemispheres with a weld having at least 100% penetration of the thickness of the hemispheres.

16. A method as set forth in claim 1, wherein, in the step of focusing, the resulting sphere has a diameter of between about 0.8 in. and about 1.5 in.

17. A method as set forth in claim 1, wherein the step of focusing includes inclining the beam at an incident angle less than about 45 degrees relative to an equatorial plane defined by the intersection of the two hemispheres.

18. A metal sphere comprising:
at least two opposing metal hemispheres, each having an exterior radius, an exterior height generated by having a portion of each hemisphere melted so that the height is substantially equal in length to that of the radius, and annular surface defined by the edges of the inner and outer surfaces of each hemisphere;
the hemispheres being coaxially aligned with their annular surfaces in contact; and
the hemispheres being welded to one another by melting a portion along their annular surfaces, such that each hemisphere has a subsequent exterior height that is substantially equal to its exterior radius.

19. A sphere as set forth in claim 18, wherein the exterior height and exterior radius has a height to radius ratio between about 1.0005 and about 1.02.

20. A sphere as set forth in claim 18, wherein the annular surface has a flatness that deviates no more than about 0.01 inches from a plane perpendicular to an axis of the hemisphere.

21. A sphere as set forth in claim 18, wherein the hemispheres are made from stainless steel.

22. A sphere as set forth in claim 18, wherein the hemispheres are made from Nanoflex™ steel.

23. A sphere as set forth in claim 18, wherein the hemispheres are made from Grade 2 titanium.

24. A sphere as set forth in claim 18, further having a diameter of between about 0.8 in. and about 1.5 in.
